(19) United States
(12) Patent Application Publication
(10) Pub. No.: US 2024/0394631 A1
(43) Pub. Date: Nov. 28, 2024

(54) DYNAMIC MULTIMODAL GRAPH PREDICTION SUPPORTED BY DIGITAL TWINS

(71) Applicant: INTERNATIONAL BUSINESS MACHINES CORPORATION, ARMONK, NY (US)

(72) Inventors: Alecio Pedro Delazari Binotto, Munich (DE); Ana Paula Appel, São Paulo (BR); PAULO RODRIGO CAVALIN, RIO DE JANEIRO (BR); Sanjay Bhaskara Panikkar, Bangalore (IN); Sujay Nandi, Kolkata (IN)

(21) Appl. No.: 18/322,133

(22) Filed: May 23, 2023

(51) Int. Cl. G06Q 10/0633

(52) U.S. Cl. CPC G06Q 10/0633

(57) ABSTRACT

A method, computer system, and a computer program product for dynamic workflow adjustment is provided. The present invention may include generating a digital workflow twin, wherein the digital workflow twin is a digital twin of an original network. The present invention may include identifying one or more potential impact regions within the digital workflow twin. The present invention may include determining whether to propose one or more recommendations to a user. The present invention may include converting at least one of the one or more recommendations into at least one new rule. The present invention may include generating a new network workflow, wherein the new network workflow is the original network with the at least one new rule integrated.

### BACKGROUND

The present invention relates generally to the field of computing, and more particularly to dynamic workflows.

Workflows are often represented by pipelines of actions which may include actions by physical entities, whereby the logical rules and/or physical entities comprising the workflow may be represented using nodes and edges. The logical rules may be rigid rules such as smart contracts which may dictate the interactions between those physical entities within the workflow and/or process. Once defined, these logical rules may restrict a workflow and/or process from adapting under different contexts. Accordingly, new scenarios may be ruled in a similar manner to previously executed and/or dissimilar workflows because network workflows and/or node rules tend to be hard-coded. Traditionally, updating workflows may require extensive computer programming and/or testing by a business and/or organization. Additionally, physical entities such as machines may be enhanced by the addition of upgrades and/or new capabilities not previously anticipated within the workflow. These upgrades and/or new capabilities may necessitate changes to the workflow.

Therefore, a system is needed that can dynamically adapt in real time by suggesting new edge-based workflow organizations and/or business rules, such as, but not limited to, new nodes' interaction and/or new smart contract rules between them. This may enable the continuous optimization of workflows within an organization and assist in dynamic adaptation towards organic growth.

### SUMMARY

Embodiments of the present invention disclose a method, computer system, and a computer program product for dynamic workflow adjustment. The present invention may include generating a digital workflow twin, wherein the digital workflow twin is a digital twin of an original network. The present invention may include identifying one or more potential impact regions within the digital workflow twin. The present invention may include determining whether to propose one or more recommendations to a user. The present invention may include converting at least one of the one or more recommendations into at least one new rule. The present invention may include generating a new network workflow, wherein the new network workflow is the original network with the at least one new rule integrated.

In addition to a method, additional embodiments are directed to a computer system and a computer program product for dynamic workflow adjustment to unique scenarios using one or more new rules integrated into a new network workflow based on simulation outcomes.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts a block diagram of an exemplary computing environment according to at least one embodiment; and

FIG. 2 is an operational flowchart illustrating a process for dynamic workflow adjustment according to at least one embodiment.

### DETAILED DESCRIPTION

The following described exemplary embodiments provide a system, method and program product for dynamic workflow adjustment. As such, the present embodiment has the capacity to improve the technical field of digital twins and multimodal dynamic graphs by adjusting to unique scenarios using one or more new rules integrated into a new network workflow based on simulation outcomes. More specifically, the present invention may include generating a digital workflow twin, wherein the digital workflow twin is a digital twin of an original network. The present invention may include identifying one or more potential impact regions within the digital workflow twin. The present invention may include determining whether to propose one or more recommendations to a user. The present invention may include converting at least one of the one or more recommendations into at least one new rule. The present invention may include generating a new network workflow, wherein the new network workflow is the original network with the at least one new rule integrated.

As described previously, workflows are often represented by pipelines of actions which may include actions by physical entities, whereby the logical rules and/or physical entities comprising the workflow may be represented using nodes and edges. The logical rules may be rigid rules such as smart contracts which may dictate the interactions between those physical entities within the workflow and/or process. Once defined, these logical rules may restrict a workflow and/or process from adapting under different contexts. Accordingly, new scenarios may be ruled in a similar manner to previously executed and/or dissimilar workflows because network workflows and/or node rules tend to be hard-coded. Traditionally, updating workflows may require extensive computer programming and/or testing by a business and/or organization. Additionally, physical entities such as machines may be enhanced by the addition of upgrades and/or new capabilities not previously anticipated within the workflow. These upgrades and/or new capabilities may necessitate changes to the workflow.

Therefore, a system is needed that can dynamically adapt in real time by suggesting new edge-based workflow organizations and/or business rules, such as, but not limited to, new nodes' interaction and/or new smart contract rules between them. This may enable the continuous optimization of workflows within an organization and assist in dynamic adaptation towards organic growth.

Therefore, it may be advantageous to, among other things, generate a digital workflow twin, wherein the digital workflow twin is digital twin of an original network, identify one or more potential impact regions within the digital workflow twin, determine whether to propose one or more recommendations to a user, converting at least one of the one or more recommendations into at least one new rule, and generate a new network workflow, wherein the new network workflow is the original network with the at least one new rule integrated.

According to at least one embodiment, the present invention may improve dynamic multimodal graph predictions, generating a graph representations, and predicting regions of the multimodal graphs by building a digital twin of a complete workflow process to support the recommendation for a modification of the interaction process (e.g., topology between nodes) and also rules (e.g., parameters, contracts) supported by the Graph Neural Network (GNN) model which enables dynamic change to real workflow according to predicted scenarios from a specific business case and/or user case defined by a user.

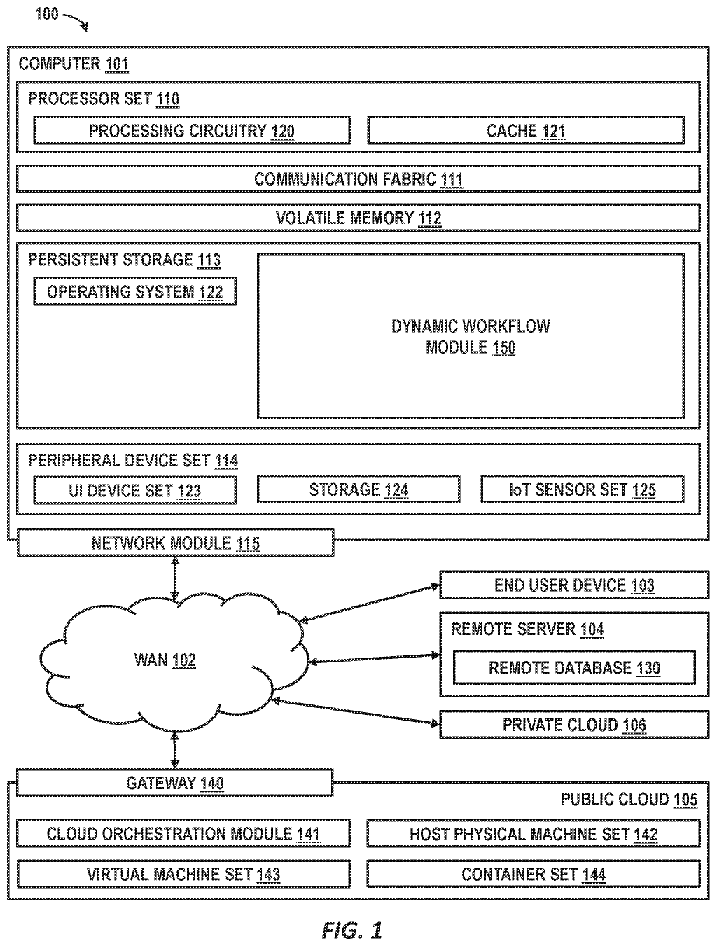

Referring to FIG. 1, Computing environment 100 contains an example of an environment for the execution of at least some of the computer code involved in performing the inventive methods, such as dynamically adjusting workflows to unique scenarios using one or more new rules integrated into a new network workflow based on previously conducted simulation outcomes using dynamic workflow module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

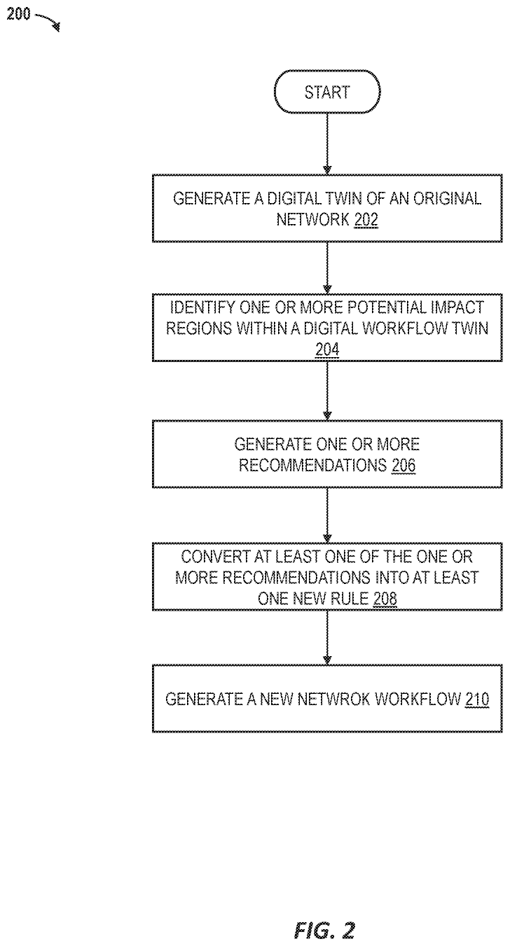

According to the present embodiment, the computer environment 100 may use the dynamic workflow module 150 to dynamically self-adapt workflows in varying scenarios. The dynamic workflow method is explained in more detail below with respect to FIG. 2.

Referring now to FIG. 2, an operational flowchart illustrating the exemplary dynamic workflow process 200 used by the dynamic workflow module 150 according to at least one embodiment is depicted.

At 202, the dynamic workflow module 150 generates a digital twin of an original network. The original network may be a graphical representation of an original workflow comprised of nodes and/or edges corresponding to logical rules and/or physical entities utilized in performing a workflow. The workflow may be a business process and/or other process performed by an organization, such as, but not limited to, the manufacturing of one or more goods on an industrial floor, safety procedure, evacuation procedure, loan approval processes, order processing, customer onboarding, amongst other processes which may be conducted by the organization. The original network may be received by the dynamic workflow module 150 directly from the user (e.g., organization, authorized party within the organization) and/or constructed by the organization based on data received and/or accessed by the dynamic workflow module 150. The original network may include different aspects of the workflow, such as, but not limited to, activities ordering, duration and/or wait times, acting resources and/or roles, business objectives, associated values, states, milestones, decisions, and/or process outcomes, amongst other aspects of the workflow.

The dynamic workflow module 150 may receive data from the user (e.g., organization, authorized party within the organization) within a workflow user interface. The workflow user interface may be displayed by the dynamic workflow module 150 in at least an internet browser, dedicated software application, and/or as an integration with a third party software application. The workflow user interface may be accessed by an EUD 103 associated with the user (e.g., organization, authorized party within the organization) and/or by logging into a secure account associated with the user (e.g., organization, authorized party within the organization). All data received and/or accessed by the dynamic workflow module 150 through the workflow user interface or otherwise shall not be construed as to violate or encourage the violation of any local, state, federal, or international law with respect to privacy protection. The dynamic workflow module 150 may require consent from the organization and/or an authorized party within the organization prior to receiving and/or accessing any data. Additionally, the user (e.g., organization, authorized party within the organization) may be able to monitor the data being shared and/or revoke access to specific data at any time within the user interface. For example, the user (e.g., organization, authorized party within the organization) may be able to revoke and/or halt access to Business Process 2 within the user interface while continuing to enable access to Business Process 1.

The data received and/or accessed by the dynamic workflow module 150 may include, but is not limited to including, metadata received from equipment, machines, and/or other physical entities utilized in performing a workflow and/or data uploaded by the user within the workflow interface, such as, but not limited to, procedures, checklists, equipment information, operating instructions, training plans, skills assessments, instructional videos, diagrams, business process event logs, task management plans, as well as event logs related to the execution of the workflow. Event logs related to the execution of the workflow may include, but are not limited to including, time stamps, corresponding activity (e.g., work item, task), identification of resource performing an activity, activity ordering, duration and/or wait times, the acting resources and/or roles, business objects and/or associated values, states, milestones, decisions, and/or process outcomes, amongst other informative data related to the execution of the workflow. The dynamic workflow module 150 may also receive and/or access data in real time from one or more IoT (Internet of Things) devices associated with the physical entities, as well as other real time data such as, but not limited to, weather data. The dynamic workflow module 150 may utilize one or more linguistic analysis techniques in analyzing the data accessed and/or received and constructing the original network, the one or more linguistic analysis techniques may include, but are not limited to including, a machine learning model with Natural Language Processing (NLP), Semantic Textual Similarity (STS), Keyword Extraction, amongst other analysis techniques, such as those implemented in IBM Watson® (IBM Watson and all Watson-based trademarks are trademarks or registered trademarks of International Business Machines Corporation in the United States, and/or other countries). IBM Watson® Natural Language Understanding, IBM Watson® Natural Language Classifier, amongst other implementations.

The dynamic workflow module 150 may store the original network (e.g., the graphical representation of an original workflow) in a knowledge corpus (e.g., database 130). The dynamic workflow module 150 may generate a digital twin for each of the original networks stored within the knowledge corpus (e.g., database 130) for which the user (e.g., organization, authorized party within the organization) has authorized access. A digital twin may be a virtual representation of an object or system which may be updated using real-time data, and may be utilized in at least, simulations, machine learning, and/or reasoning in aiding informed decision making. Digital twins may be utilized in answering what-if questions, presenting insights in an intuitive way, and/or providing a way to interact with stakeholders through different types of representations (e.g., photogrammetry, Building Information Modeling (BIM), within a variety of delivery models (e.g., web portal, Augmented Reality (AR), Virtual Reality (VR)) which may be integrated with the workflow interface and accessed utilizing the EUD 103 associated with the user (e.g., organization, authorized party within the organization) and/or by logging into a secure account associated with the user (e.g., organization, authorized party within the organization).

The digital workflow twin may be a digital representation of the complete workflow as a multimodal dynamic graph which may represent the logical rules and/or physical entities as well as their interactions with actors within the organization which may be utilized in simulations to predict different scenarios. As will be explained in more detail below, the dynamic workflow module 150 may utilize the digital workflow twin to dynamically reconfigure the original network and/or corresponding original workflow by building new rule engines based on a set of most likely scenarios predicted using one or more machine learning models. As will be explained in more detail below, the dynamic workflow module 150 may utilize at least Graph Neural Networks (GNNs) to support the capturing and/or learning within neighbors' (e.g., physical edge, digital nodes, actor nodes) actions within different time frames.

The graph representation of the original network comprising logical rules and/or physical entities forming a multimodal dynamic graph which may be comprised of a correspondence of existing nodes and/or edges from the original workflow. As will be explained in more detail below, the digital workflow twin (e.g., the graph representation of the original network) may be utilized in predicting regions of the multimodal dynamic graph which may have an impact exceeding a predetermined threshold on a predetermined business case using the artificial intelligence model-based simulations which may include the GNN to identify a scenario to be improved.

At 204, the dynamic workflow module 150 identifies one or more potential impact regions within the digital workflow twin. The one or more potential impact regions within the digital workflow twin may be events and/or activities within the workflow which exceed a predefined threshold under simulated scenarios. The dynamic workflow module 150 may utilize the one or more potential impact regions identified within the digital twin for at least establishing one or more scenarios which may be improved. As will be explained in more detail below, the predefined threshold may be set by a user (e.g., organization, authorized party within the organization) for a specific business case. The predefined threshold and/or business case being set within the workflow interface manually by the user (e.g., organization, authorized party within the organization) and/or automatically by the dynamic workflow module 150.

The dynamic workflow module 150 may utilize one or more machine learning models, such as, but not limited to GNNs, Convolutional Neural Networks (CNNs), Artificial Neural Networks (ANNs), Support Vector Machine (SVM), K-Nearest Neighbors (KNN), Naïve Bayes, and/or a hybrid model in identifying the one or more potential impact regions within the digital workflow twin. The hybrid model may be trained to combine the predictions of two or more machine learning models. For example, the dynamic workflow module 150 may utilize node and/or edge disruptions within the digital workflow twin in future scenarios in identifying one or more potential impact regions within the digital workflow twin using the GNN. As will be explained in more detail below, the dynamic workflow module may run one or more simulations with the GNN and/or other machine learning models to predict nodes and/or edges within the digital workflow twin which may correspond to the one or more potential impact regions.

For example, a digital workflow twin may be generated comprising virtual substations, consumer demands, and peers in an Energy Workflow. The dynamic workflow module 150 may utilize the GNN to support the process of the digital workflow twin such the entities and rules they interact according to may be linked. The dynamic workflow module may run one or more machine learning algorithms based on actions captured from the workflow comprised of the digital and physical entities and the transactions between the entities over, for example, n−1 iterations to build a rule engine for switching operations in specific substations. As will be explained in more detail below, the new rule engines may be recommended to the user (e.g., organization, authorized party within the organization). Upon approval, the dynamic workflow module 150 may dynamically reconfigure the original network.

In training the GNN and/or other machine learning model in the dynamic workflow module we are using historical data to build a network and then the GNN use the network to predict new connection based on historical data or nodes and/or edges (e.g., connections that had a problem and were removed from the network). The GNN may utilize the same graph to train, score, and/or generate predictions which may be based on the similarity function defined by the user in what should be considered similarity, for example, the number of common neighbors, similarity in node information, etc. This may utilize the following equation:

$$ℒ = {\sum }_{v ∈ V} {y}_{v} log ( σ ( {z}_{v}^{⊤} θ ) ) + ( 1 - {y}_{v} ) log ( 1 - σ ( {z}_{v}^{⊤} θ ) )$$

yᵥ representing a node class label, z_{y} representing an output node embedding, and θ representing the classification weights. For example, training the GNN may involve the propagation of node labels across a network. In this example, the class probability yᵥ of node v may be a weighted average of class probabilities of its neighbors. For labeled nodes v, the dynamic workflow module 150 may initialize label yᵥ with ground truth label y*_{#}. For unlabeled nodes, the dynamic workflow module 150 may initialize label yᵥ with yᵥ=0.5. The dynamic workflow module 150 may update all nodes in a random order until convergence and/or until a maximum number of iterations may be reached. The dynamic workflow module 150 may also utilize the following equation in updating the GNN parameters:

$${θ}_{t + 1} = {θ}_{t} - η {∇}_{{θ}_{t}} {ℒ}_{GNN}$$

The GNN parameters may be updated based on previous interactions and the nodes connected with the node that is being updated. The equations described above may represent one embodiment by which the GNN may be trained and the GNN parameters may be updated. In other embodiments, the dynamic workflow module 150 may utilize other machine learnings models such as those described previously, other methods of training, and/or other methods in updating the machine learning model parameters.

For example, the original network (e.g., the graphical representation of an original workflow) for which the digital workflow twin may be generated may be for a financial service provided by the user and/or organization. The dynamic workflow module 150 may utilize the GNN to subsample the digital workflow twin graph and limit the scope of the one or more simulations to be performed. These simulations may be distinguishable from predictive analysis because the digital workflow twin may be able to take diverse variables into account and it may be possible to generate multiple outcomes. Additionally, this may enable the dynamic workflow module 150 to continue to alter and/or adjust different variables within the financial service such that simulations may be conducted for scenarios the user and/or organization has not previously encountered. Continuing with the example, the dynamic workflow module 150 may be utilized in understanding the challenges climate change may present for credit risk. The dynamic workflow module 150 would be able to consider the physical risks, such as, but not limited to, different natural phenomena which may affect the energy section, change demand for resources, and/or infrastructure damage, as well as other physical risks. Additionally, the dynamic workflow module 150 would be able to consider transition risks, transition risks may involve the friction arising from transitioning to sustainable energy and/or other climate change-reducing solutions, such as, but not limited to, policy, legislation, technology development, reputational risk, as well as other transition risks. The dynamic workflow module 150 may enable the user and/or organization to understand how these environmental factors may translate into credit risk. Customers previously considered low risk may be at risk due to insufficient income generation to service their debt or collateral backing that debt may be at risk due to environmental changes which may not be adequately understood by existing models. Here, the dynamic workflow module 150 may coupe a physical model of weather and a transactional model of risk and utilize the one or more simulations and the predictions of the machine learning models as a GNN for transactional data which may enable the dynamic workflow module 150 to reduce the scope of the simulations and offer a personalized credit risk to the user.

The dynamic workflow module 150 may also utilize the one or more machine learning models in identifying one or more potential impact regions within the digital workflow twin based on one or more performance metrics. The one or more performance metrics may include, but are not limited to including, bottlenecks within the workflow, long durations and/or wait times in activity executions, lagging Key Performance Indicators (KPIs), process outcomes, physical entity performance, consumption, output produced (e.g., throughput), amongst other performance metrics. The user may manually input within the workflow interface predefined thresholds corresponding to the one or more performance metrics for a specific business case.

The dynamic workflow module 150 may also perform one or more simulations using the digital workflow twin based on the specific business case and/or use case defined by the user within the workflow interface. The dynamic workflow module 150 may display the digital workflow twin to the user within the workflow interface and enable the user to select specific at least specific nodes, edges, and/or situations to be simulated. Perturbation on simulations may be caused by an external factor such as node disruption and/or degradation. In the case of degradation, the dynamic workflow module 150 may utilize the one or more machine learning models described above and/or one or more simulation models in estimating future conditions of degradation. The one or more simulation models may include, but are not limited to including, a Monte Carlo simulation process, agent based simulation model, discrete event simulation model, and/or a system dynamic simulation model, amongst other simulation methods. The dynamic workflow module 150 may additionally utilize a statistical program such as IBM's SPSS® (SPSS® and all SPSS-based trademarks are trademarks or registered trademarks of International Business Machines Corporation in the United States, and/or other countries), or Statistical Product and Service Solution, in optimizing the one or more simulation methods.

The dynamic workflow module 150 may perform the one or more simulations using the digital workflow twin based on the specific business case and/or use case defined by the user within the workflow interface. For example, assume a physical entity such as a machine (e.g., node) has seen a decreasing performance within the last few months, based on the one or more performance metrics derived from the data accessed and/or received from the user. The dynamic workflow module 150 may utilize this trend to predict its impact in the digital workflow twin. In this example, the dynamic workflow module 150 may additionally leverage a supporting model to predict these trends, the supporting model may be for example an Autoregressive Integrated Moving Average (ARIMA) model. An alternative example may be a perturbation related to an edge disruption. In this example, the dynamic workflow module 150 may employ a set of mitigation actions derived from a mitigations database that may be employed by the user (e.g., organization, authorized party within the organization) to replace the disrupted node. The mitigations database may be a separate database stored within the knowledge corpus (e.g., database 130) which may be used to prescribe remedial actions on the possible disruptions for the specific business case and/or use case defined by the user. The remedial actions being identified by the dynamic workflow module 150 based on the one or more simulations performed.

For example, the dynamic workflow module 150 may be utilized by a user that owns a farm and the one or more simulations may be utilized in computing a risk score for that farm. The dynamic workflow module 150 may utilize traditional data, such as, but not limited to, transactional data, and also weather data, to predict climate risk that the user may experience as well as the value of the climate risk. The dynamic workflow module 150 may utilize the one or more machine learning models described above to predict a weather model and simulate one or more different scenarios, such as, but not limited to, different weather catastrophes with the weather model in the digital workflow twin to produce a credit risk not only for a bank associated with the farm but also the farmer. The dynamic workflow module 150 in this example may also provide one or more recommendations to the user, such as, but not limited to, modifications to the original workflow for different weather catastrophes and/or different insurance recommendations.

In performing a set of simulations on a scenario identified using a representation from the original network, the dynamic workflow module 150 may utilize a case including nodes, edges, and/or situations defined by the user (e.g., organization, authorized party within the organization) within the workflow interface. For example, the user may be able to identify a specific region within multimodal dynamic graph and/or representation from the original network including the nodes and/or edges within that specific region and the user may further manually enter and/or select from a list of predetermined scenarios which situations may be simulated in the set of the simulations. As will be explained in more detail below, the set of simulations may be utilized by the dynamic workflow module 150 in generating additional predictions for rules given different predicted topologies originated from the set of simulations and/or real data using the GNN to create a recommendation for the scenario identified by the user in the workflow interface. The dynamic workflow module 150 may generate the recommendations and determine whether to propose the recommendation using at least a predetermined objective function and/or a threshold defined by the original workflow. The predetermined objective function may include, but is not limited to including, maximizing speed, minimizing lost, amongst other predetermined objective functions of the one or more machine learning algorithms utilized by the dynamic workflow module 150.

At 206, the dynamic workflow module 150 generates one or more recommendations. The dynamic workflow module 150 may determine whether to propose the one or more recommendations generated to the user (e.g., organization, authorized party within the organization). The dynamic workflow module 150 may determine whether to propose the one or more recommendations to the user (e.g., organization, authorized party within the organization) based on at least a predetermined objective function and the predefined threshold of the original workflow corresponding to the one or more potential impact regions identified within the digital workflow twin. The one or more potential impact regions corresponding to a specific region of the multimodal graph and the edges and/or nodes within the specific region identified by the user (e.g., organization, authorized party within the organization) within the workflow interface as described in further detail above with respect to step 204. the one or more recommendations may be new connections (i.e., edges on the multimodal graph) identified by the dynamic workflow module 150 using the GNN.

The one or more recommendations may be proposed to the user (e.g., organization, authorized party within the organization) by the dynamic workflow module 150 in the workflow interface. The one or more recommendations may be presented to the user (e.g., organization, authorized party within the organization) along with data gathered from the one or more simulations performed at step 204. The data gathered from the one or more simulations performed at step 204 may enable the user (e.g., organization, authorized party within the organization) to make an informed decision with respect to the one or more recommendations proposed. The one or more recommendations proposed may include more than one recommendation for a single scenario and the user (e.g., organization, authorized party within the organization) may select at least one recommendation corresponding to each of the scenarios which may be converted into at least one new rule to be integrated into the workflow as will be explained in more detail below with respect to at least step 208. The one or more recommendations may one or more solutions to the one or more scenarios defined by the user (e.g., organization, authorized party within the organization) in the workflow interface, wherein the one or more recommendations may bring the one or more potential impact regions below the predefined threshold for the one or more scenarios defined. For example, the one or more recommendations could be to change a supplier, update a product route, specific supply chain recommendations, and/or other workflow adjustments which may apply to the workflow and/or business processes identified by the user at step 202. As will be explained in more detail below, the dynamic workflow module 150 may only propose recommendations to the user over a predetermined threshold for the user's approval, the recommendations below the predetermined threshold may be stored in the knowledge corpus (e.g., database 130) along with additional information such that the user may later evaluate recommendations which may not have been proposed.

Additionally, the one or more recommendations selected by the user (e.g., organization, authorized party within the organization) within the workflow interface may be utilized in retraining at least the one or more machine learning models described in detail above. Such that future recommendations may be personalized to the user (e.g., organization, authorized party within the organization). As will be explained in more detail below, the dynamic workflow module 150 may, in response to determining to propose the one or more recommendations, may convert the recommendations into new rules which may be inserted in in the knowledge corpus (e.g., database 130) which may enable the original network and/or workflow to be reconfigured. Furthermore, the new workflow may be published with links representing the new rules converted in connections and/or links of the original network which may enable the dynamic workflow module 150 to annotate scenarios from the simulations for future model improvements.

At 208, the dynamic workflow module 150 converts at least one of the one or more recommendations into at least one new rule. The dynamic workflow module 150 may store the at least one new rule in the knowledge corpus (e.g., database 130) and/or insert the at least one new rule into a system knowledge repository.

As will be explained in more detail below with respect to at least step 210, the at least one new rule generated by the dynamic workflow module 150 may integrated into the original network (e.g., graphical representation of an original workflow) using one or more smart contracts. The one or more smart contracts may be stored within the knowledge corpus (e.g., database 130) and may be a program that executes upon the fulfillment of predetermined conditions. The one or more smart contracts may be remedial measures which may be taken to address specific scenarios for which the dynamic workflow module 150 previously performed one or more simulations as described in detail above. For example, upon approval of the at least one recommendation, the dynamic workflow module 150 may automatically build the at least one new rule into a smart contract after n−1 iterations over a success threshold. By storing the new network workflow in the knowledge corpus (e.g., database 130) the dynamic workflow module 150 may additionally be able to store at least one or more reasons for the at least one new rule and a cause for including the at least one new rule in the new network workflow, which may include, but is not limited to including, models, simulations, new suggested rules and links, additional what-if scenarios, user decisions based on respective what-if scenarios, amongst other information which may be utilized in updating future iterations of the workflow.

Additionally, in response to a determination not to propose a recommendation to the user, the dynamic workflow module 150 may label the scenario for which the recommendation was not proposed to the user and update the knowledge corpus (e.g., database 130) with information associated with the recommendation not proposed. This information may be accessible to the user (e.g., organization, authorized party within the organization) within the workflow interface. The user may choose to override the dynamic workflow module's determination and choose to implement the proposed recommendation as a at least one additional new rule. Accordingly, the dynamic workflow module 150 may adjust the predetermined objective functions and/or predefined thresholds such that similar recommendations may be proposed to the user and/or automatically implemented. The dynamic workflow module 150 may additionally utilize the recommendations not accepted by the user in retraining the one or more machine learning algorithms and/or recommendation algorithms utilized in providing the one or more recommendations to the user, wherein the recommendations algorithms may be retrained based on the information associated with the recommendation not accepted by the user.

At 210, the dynamic workflow module 150 generates a new network workflow. The new network may be the original network (e.g., graphical representation of an original workflow) in which the dynamic workflow module 150 may integrate the at least one new rule. The dynamic workflow module may integrate the at least one new rule by converting connections and/or links within the original network such that future scenarios are annotated for future improvements to the new network.

The one or more future scenarios may be labeled based on a ground truth in the case that the one or more future scenarios takes place based on the simulations previously conducted. For example, the dynamic workflow module 150 may recommend the user buy a product from another vendor based on supply chain disruptions occurring in the plurality of simulations. The user may implement this recommendation and source the product from a different vendor based on the new rule implemented in the new network workflow. The dynamic workflow module 150 may monitor the what-if scenario of the user remaining with the previous vendor and the original workflow, if the supply chain disruption which was previously simulated occurs the dynamic workflow module may label this scenario and store the information within the knowledge corpus (e.g., database 130) which may be utilized in providing future recommendations and/or simulating other scenarios.

The dynamic workflow module may store the new network workflow in the knowledge corpus (e.g., database 130). The dynamic workflow module 150 may store the new network workflow with the recommendations accepted by the user and the corresponding new rules. The dynamic workflow module 150 may continuously receive data from the user (e.g., organization, authorized party within the organization), one or more IoT devices associated with the one or more physical entities utilized in the workflow, as well as other real time data, such as, for example, the weather data described at step 204. The dynamic workflow module 150 may utilize this data in dynamically changing edge-based networks and/or rules between edge nodes of the new network to execute different scenarios and/or simulations on a digital workflow twin of the new network. The digital twin of the new network may be supported by the GNN and/or other machine learning models described above such that the digital twin of the new network may continuously learn from the real time data and dynamically optimize and/or reconfigure for simulated scenarios identified by using the real time data. The dynamic workflow module 150 may dynamically optimize and/or reconfigure the digital twin of the new network workflow by at least retraining the one or more machine learning models utilized in supporting the digital twin of the new network based on the data received.

It may be appreciated that FIG. 2 provides only an illustration of one embodiment and do not imply any limitations with regard to how different embodiments may be implemented. Many modifications to the depicted embodiment(s) may be made based on design and implementation requirements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of one or more transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed as to violate or encourage the violation of any local, state, federal, or international law with respect to privacy protection.

What is claimed is:

1. A method for dynamic workflow adjustment, the method comprising:
generating a digital workflow twin, wherein the digital workflow twin is a digital twin of an original network;
identifying one or more potential impact regions within the digital workflow twin;
generating one or more recommendations and determining whether to propose the one or more recommendations to a user;
converting at least one of the one or more recommendations into at least one new rule; and
generating a new network workflow, wherein the new network workflow is the original network with the at least one new rule integrated.

2. The method of claim 1, wherein the original network is a graphical representation of an original workflow, wherein the graphical representation is comprised of nodes and edges corresponding to logical rules and physical entities utilized in performing a workflow within an organization.

3. The method of claim 2, wherein the one or more scenarios are defined by the user in a workflow interface, wherein the user selects at least one or more specific nodes, edges, or scenarios to be simulated.

4. The method of claim 2, wherein the one or more potential impact regions within the digital workflow twin are events or activities within the workflow which exceed a predefined threshold under one or more scenarios.

5. The method of claim 4, wherein the predefined threshold is manually set by the user within a workflow interface.

6. The method of claim 1, wherein the one or more potential impact regions within the digital workflow twin are identified using one or more machine learning models and one or more performance metrics.

7. The method of claim 6, wherein the one or more machine learning models includes at least a Graph Neural Network, wherein the Graph Neural Network is trained to predict nodes or edges that correspond to the one or more potential impact regions.

8. The method of claim 6, wherein a digital twin of the new network workflow is supported by the one or more machine learning models, wherein the one or more machine learning models are continuously retrained based on additional data received.

9. A computer system for dynamic workflow adjustment, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
generating a digital workflow twin, wherein the digital workflow twin is a digital twin of an original network;
identifying one or more potential impact regions within the digital workflow twin;
generating one or more recommendations and determining whether to propose the one or more recommendations to a user;
converting at least one of the one or more recommendations into at least one new rule; and
generating a new network workflow, wherein the new network workflow is the original network with the at least one new rule integrated.

10. The computer system of claim 9, wherein the original network is a graphical representation of an original workflow, wherein the graphical representation is comprised of nodes and edges corresponding to logical rules and physical entities utilized in performing a workflow within an organization.

11. The computer system of claim 10, wherein the one or more scenarios are defined by the user in a workflow interface, wherein the user selects at least one or more specific nodes, edges, or scenarios to be simulated.

12. The computer system of claim 10, wherein the one or more potential impact regions within the digital workflow twin are events or activities within the workflow which exceed a predefined threshold under one or more scenarios.

13. The computer system of claim 12, wherein the predefined threshold is manually set by the user within a workflow interface.

14. The computer system of claim 9, wherein the one or more potential impact regions within the digital workflow twin are identified using one or more machine learning models and one or more performance metrics.

15. The computer system of claim 14, wherein the one or more machine learning models includes at least a Graph Neural Network, wherein the Graph Neural Network is trained to predict nodes or edges that correspond to the one or more potential impact regions.

16. The computer system of claim 14, wherein a digital twin of the new network workflow is supported by the one or more machine learning models, wherein the one or more machine learning models are continuously retrained based on additional data received.

17. A computer program product for dynamic workflow adjustment, comprising:
one or more computer readable storage media, and program instructions collectively stored on the one or more computer readable storage media, the program instructions comprising:
generating a digital workflow twin, wherein the digital workflow twin is a digital twin of an original network;
identifying one or more potential impact regions within the digital workflow twin;
generating one or more recommendations and determining whether to propose the one or more recommendations to a user;
converting at least one of the one or more recommendations into at least one new rule; and
generating a new network workflow, wherein the new network workflow is the original network with the at least one new rule integrated.

18. The computer program product of claim 17, wherein the original network is a graphical representation of an original workflow, wherein the graphical representation is comprised of nodes and edges corresponding to logical rules and physical entities utilized in performing a workflow within an organization.

19. The computer program product of claim 18, wherein the one or more scenarios are defined by the user in a workflow interface, wherein the user selects at least one or more specific nodes, edges, or scenarios to be simulated.

20. The computer program product of claim 18, wherein the one or more potential impact regions within the digital workflow twin are events or activities within the workflow which exceed a predefined threshold under one or more scenarios.

21. A method for dynamic multimodal graph prediction, the method comprising:
generating a graph representation of an original network comprising logical rules and physical entities forming a multimodal dynamic graph comprising a correspondence of existing nodes and edges from an original workflow;
predicting regions of the multimodal dynamic graph having an impact exceeding a predetermined threshold on a predetermined business case using artificial intelligence model-based simulations including a graph neural network (GNN), to identify a scenario to be improved;
performing a set of simulations on the scenario identified using a representation from the original network using a case including nodes, edges and situations defined by a user;
generating additional predictions for rules given different predicted topologies originated from the set of simulations and real data using GNN to create a recommendation for the scenario identified;
converting the recommendation into new rules inserted in a system knowledge repository enabling network/workflow reconfiguration; and
publishing a new workflow and links representing the new rules converted in connections and links in the original network.

22. The method of claim 21, further comprising:
annotating scenarios from the simulations for future model improvements; and
storing the new workflow in the system knowledge repository.

23. The method of claim 22, further comprising:
storing in the system knowledge repository at least one of a reason and cause including models, simulations, new suggested rules and links, what-if scenario, user decisions based on a respective what-if scenario to update the system knowledge repository;
in response to a determination not to propose the recommendation, labeling the scenario; and
updating the system knowledge repository with information associated with the recommendation not proposed.

24. A computer system dynamic multimodal graph prediction, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
generating a graph representation of an original network comprising logical rules and physical entities forming a multimodal dynamic graph comprising a correspondence of existing nodes and edges from an original workflow;
predicting regions of the multimodal dynamic graph having an impact exceeding a predetermined threshold on a predetermined business case using artificial intelligence model-based simulations including a graph neural network (GNN), to identify a scenario to be improved;
performing a set of simulations on the scenario identified using a representation from the original network using a case including nodes, edges and situations defined by a user;
generating additional predictions for rules given different predicted topologies originated from the set of simulations and real data using GNN to create a recommendation for the scenario identified;
converting the recommendation into new rules inserted in a system knowledge repository enabling network/workflow reconfiguration; and
publishing a new workflow and links representing the new rules converted in connections and links in the original network.

25. The computer system of claim 24, further comprising:
program instructions, stored on at least one of the one or more computer-readable storage media for execution by at least one of the one or more processors via at least one of the one or more memories, to annotate scenarios from the simulations for future model improvements; and
program instructions, stored on at least one of the one or more computer-readable storage media for execution by at least one of the one or more processors via at least one of the one or more memories, to store the new workflow in the system knowledge repository.
